(19) United States
(12) Patent Application Publication
(10) Pub. No.: US 2009/0006219 A1
(43) Pub. Date: Jan. 1, 2009

(54) METHOD FOR DISTRIBUTION OF AN AQUARIUM KIT

(76) Inventors: Alan Blake, Austin, TX (US); Joseph Diaz, Plant City, FL (US)

Correspondence Address: Vista IP Law Group LLP, 2040 MAIN STREET, 9TH FLOOR, IRVINE, CA, 92614, US

(21) Appl. No.: 12/164,051

(22) Filed: Jun. 28, 2008

Related U.S. Application Data
(60) Provisional application No. 60/946,985, filed on Jun. 29, 2007.

(51) Int. Cl. G06Q 30/00

(52) U.S. Cl. 705/26; 705/41

(57) ABSTRACT

A method for distributing an aquarium kit through use of a Gift Card or Redemption Card. The Redemption Card is similar to a gift card and will entitle consumers to redeem an aquarium kit, via phone or internet, for direct shipment to any desired location. The Redemption Card will eliminate the hassle of purchasing an aquarium and fish, which often requires multiple transactions, and will free them from dedicating up to several hours in the process. Instead, the aquarium kit will conveniently arrive at the desired location ready for immediate setup.

### RELATED APPLICATIONS

This Application claims the benefit of U.S. provisional Application No. 60/946,985, filed on Jun. 29, 2007, in accordance with 35 U.S.C. Section 119(e), and any other applicable laws. U.S. provisional Application No. 60/946,985 is hereby incorporated by reference in its entirety as if set forth fully herein.

### FIELD OF THE INVENTION

The present invention relates generally to the distributions of aquariums with ornamental fish, and more particularly to a business method for aquarium kit distribution through use of a Redemption Card or Gift Card.

### BACKGROUND OF THE INVENTION

Aquariums are typically comprised of a tank which can be filled with water, a system for maintaining the condition of the water (e.g. filter, aeration pump, heater), and ornamental features such as plants, gravel, rocks and curios. The tank may be of any shape such as rectangular tanks or round bowls, and the sides of the tank are typically transparent. The aquarium may also comprise a lighting system.

Ornamental fish have been widely marketed for many years worldwide, and are commonly used for companionship and decorative displays. They are available in hundreds of varieties, including transgenic fluorescent ornamental fish. For maximum health and aesthetic quality, ornamental fish are often kept in aquariums such as those described above.

Establishing an aquarium with ornamental fish often requires a great deal of time and planning on the part of consumers, as the consumer must purchase the fish, aquarium, and all related items (referenced above). Because the fish have a very limited ability to live outside of an aquarium, consumers often must dedicate several hours specifically to purchasing and transporting ornamental fish, and immediately acclimating them to their aquarium. While it is possible to order aquariums and fish via mail from catalogs or web sites, there is no system that utilizes a Redemption Card or Gift Card to facilitate distribution.

### SUMMARY OF THE INVENTION

The present invention is directed to business method for distributing aquariums with ornamental fish via a Redemption Card or Gift Card. The aquarium kit is defined herein to comprise at least one fish and a tank for containing a volume of water. It may also include, without limitation, a light source, a water filter, an air pump, gravel, food, water conditioner. For the purposes of the present invention, a Gift Card is an item or electronic credit that comprises a redemption code entitling the holder to redeem a specified monetary amount towards the purchase of an aquarium kit. The Gift Card may be issued such that it is worth any suitable amount, but denominations may include, without limitation, the following: between $10 and $500; $15, $20, $25, $30, $35, $40, $45, $50, $55, $60, $65, $70, $75, $80, $85, $90, $95, $100, $125, $150, $175, $200, $250, and $500. According to the present invention, a Redemption Card is an item or electronic credit similar to a Gift Card. A Redemption Card also comprises a redemption code, and rather than entitling the holder to redeem a specified monetary amount, they may also entitle the holder to redeem a particular product or products. In this case, the Redemption Card entitles the holder to redeem an aquarium kit, to be shipped to any desired location. The Gift Card and Redemption Card are intended to be available for purchase in a wide variety of retail outlets, as well as online. Examples of potential markets, without limitation, include malls, and more specifically, mall kiosks, college campuses, retail locations, including chains and independent locations, academic fundraisers, and more specifically scrip programs or similar fundraising programs, consumer shopping channels, such as the Home Shopping Network and QVC. As used herein, scrip is defined to mean programs that utilize gift cards to provide a form of substitute money for fundraising. Information about scrip programs can be found at www.scrip.com and those experienced in the field of fundraising for academic programs are known to be very familiar with scrip programs.

In another aspect of the present invention, in some cases, the redemption code may be immediately valid upon the initial sale of the Gift Card or Redemption Card to a retail vendor. In such cases, the code, also known as a pin code, will be hidden under a “scratch-off” coating, much like the types of coatings that are commonly used on scratch-off lottery tickets or pre-paid calling cards.

In other cases, this redemption code may be inactive until electronically activated upon retail sale by the vendor. In these cases, the scratch-off coating described above may be utilized, but is not necessary, as the code is not valuable until activated by the merchant. Such activation will be achieved by processes similar to those used in charging a credit card and they are well known by those with ordinary knowledge in the field. Various companies that offer services capable of activating Gift Cards or Redemption Cards codes include, for example, First Data/Valuelink, Comdata, OptInc, and Chockstone. Both types of cards may be configured to meet the specifications as described by ISO/IEC 7810:2003(E), the contents of which is incorporated by reference herein in its entirety.

In either case, the holder of the Gift Cards or Redemption Card may redeem the card by phone or by internet Redemption will entitle the holder to either receive an aquarium kit or the specified monetary value towards the purchase of an aquarium kit shipped via express mail to the desired location.

The business method of the present invention includes one or more of the following steps, although not necessarily in this order:

1. The merchant of the aquarium kit produces the Gift Card or Redemption Card, for example, as described above. One method for doing this would be working with one of the companies named above, or a company that provides similar services. Alternatively, the cards could be produced without the help of a company that offers such formal services, with such cards likely containing active codes upon sale to the retail outlet.

2. The merchant sells the Gift Card or Redemption Card to a retail outlet, or directly to customers. Alternatively, the cards may be provided to a retail outlet, and the retail outlet is only charged for the Gift Card or Redemption Card when the retail outlet sells the card to a customer.

3. The retail outlet offers Gift Card or Redemption Card for sale.

4. A customer purchases the Gift Card or Redemption Card. If the Gift Card or Redemption card was not already active, the retailer would activate the card by swiping the Gift Card or Redemption Card through an appropriate processing terminal (such as Verifone).

5. The Gift Card or Redemption Card is considered live tender at this point in time.

6. Customer visits a web site or calls a phone number to redeem their Gift Card or Redemption Card, and the website receives the redemption code, and verifies the code.

7. In cases where a pin code is obscured by a scratch off coating, the customer would remove this coating to redeem their Gift Card or Redemption Card.

8. Customer goes through check out process at website or over phone and uses their Gift Card or Redemption Card pin code as tender to pay for their transaction.

9. In the case of a Gift Card, if the cost of the purchase exceeds the amount of the face value that the Gift Card does not cover, the customer is instructed to pay for the balance with another form of payment. If there is extra value left on the Gift Card, that value will remain on the card, and may be used for future purchases.

10. Customer completes purchase.

11. Merchandise is shipped to customer by the merchant.

### BRIEF DESCRIPTION OF THE DRAWINGS

FIG. 1 is a top view of a Gift Card or Redemption Card in accordance with an exemplary embodiment of the present invention for retail marketing.

### DETAILED DESCRIPTION OF THE INVENTION

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

The present invention is directed to an innovative business method for distributing aquarium kits via a pre-paid card, such as a Gift Card or Redemption Card. The aquarium kit comprises at least one fish and a tank for containing a volume of water and the fish. The kit may further comprise, for example, a light source, a water filter, an air pump, gravel, food, water conditioner, and other accessories.

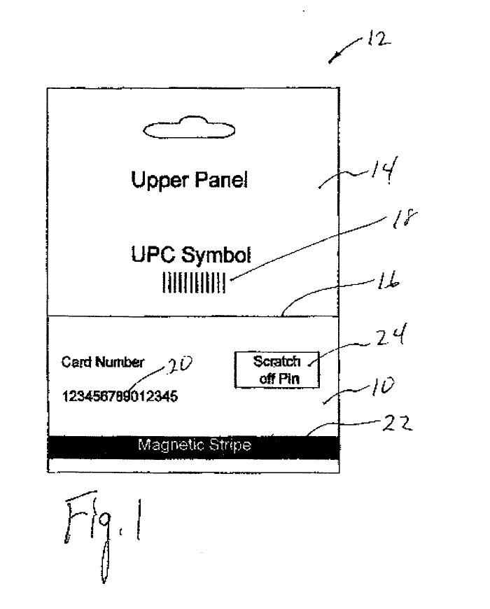

According to the one embodiment of the present invention, a Gift Card or Redemption Card 10 is produced by the merchant of the aquarium kit. Referring to FIG. 1, one embodiment for a Gift Card or Redemption Card, collectively referred to as a card 10. The Card 10 may be produced as a part of a display carrier 12 as shown in FIG. 1. The carrier 12 comprises an upper panel 14 which is detachably connected to the Card 10. For example, the upper panel 14 and Card 10 may be integrally formed with a score along the detachment line 16. The upper panel 14 may be provided with a UPC code 18, as is know in the art. The Card 10 includes a card number 20, a magnetic stripe 22, and an optional scratch off pin code 24. The magnetic stripe 22 is readable by standard credit card readers and the like, and includes the card information, for example the card number, redemption value of the card, and other merchant and/or retailer information. The scratch off pin code 24 comprises a redemption code or pin code hidden under a scratch off material. The card 10 may further comprise instructions for redeeming the card 10, as described below.

As explained above, for the purposes of the present invention, a Gift Card 10 is an item or electronic credit that comprises a redemption code entitling the holder to redeem a specified monetary amount towards the purchase of an aquarium kit. The Gift Card may be issued such that it is worth any suitable amount, but denominations may include, without limitation, the following: between $10 and $500; $15, $20, $25, $30, $35, $40, $45, $50, $55, $60, $65, $70, $75, $80, $85, $90, $95, $100, $125, $150, $175, $200, $250, and $500.

According to the present invention, a Redemption Card 10 is an item or electronic credit similar to a Gift Card 10, but instead of a specified monetary amount, it entitles the holder to redeem a particular product or products. In this case, the Redemption Card 10 entitles the holder to redeem an aquarium kit, to be shipped to any desired location.

The card 10 may be immediately valid upon the initial sale of the card 10 to a retail vendor. In such cases, the code 24, also known as a pin code, will be hidden under a “scratch-off” coating, much like the types of coatings that are commonly used on scratch-off lottery tickets or pre-paid calling cards.

Alternatively, the card 10 may be inactive until electronically activated upon retail sale by the vendor. In these cases, the scratch-off coating described above may be utilized, but is not necessary, as the card 10 is not valuable until activated by the merchant. Such activation will be achieved by processes similar to those used in charging a credit card and they are well known by those with ordinary knowledge in the field. Various companies that offer services capable of activating Gift Cards or Redemption Cards codes include, for example, First Data/Valuelink, Comdata, OptInc, and Chockstone.

The card 10 is then distributed through retail outlets or other distribution methods such as sale on internet websites. The card 10 is intended to be available for purchase in a wide variety of retail outlets, as well as online. The card may be distributed at various stores, pet stores, mall kiosks, college campuses, retail locations, including chains and independent locations, academic fundraisers, and more specifically scrip programs or similar fundraising programs, consumer shopping channels, such as the Home Shopping Network and QVC.

The merchant may then sell the card 10 to the retail outlets, including physical stores and internet retailers. In such case, the merchant would receive payment for the cards 10 at the time they are distributed. Alternatively, the cards 10 may be provided to retail outlets initially without charging the retail outlet. Then, the retail outlet would only be charged for the Gift Card or Redemption Card when the retail outlet sells the card 10 to a customer.

The retail outlet then offers the cards 10 for sale to customers. When a customer purchases a card 10 from a retail outlet, if the card 10 is not already activated, the retailer activates the card 10, such as by swiping the card 10 through a processing terminal, such as Verifone. At this point in the process, the card 10 is considered live tender capable of use for purchasing product from the merchant.

Now, the holder of the card 10 may redeem the card 10 from the merchant by phone or through a website on the internet. In the case of a Gift Card, redemption will entitle the holder to purchase a specified monetary value of product from the merchant, such as an aquarium kit and various accessories. In the case of a Redemption Card, redemption will entitle the holder to purchase an aquarium kit. The card 10 may also include shipping, such as express shipping or other suitable shipping method.

The card holder may call a phone number listed on the card 10 to redeem the card 10. Or, the card holder may visit a website to redeem the card. In either case, the card holder provides the card number 20 and the pin code 24. If the pin code 24 is obscured by a scratch off coating, the card holder simply removes the coating to reveal the code. The card holder selects the products, such as a desired aquarium kit, to purchase with the card 10. Then, the card holder goes through a check out process using the value of the card 10 to pay for the products. In the case of a Gift Card having a specified value, if the cost of the selected products exceeds the Gift Card value, the card holder is required to submit payment of the balance with another form of payment, such as a credit card. If there is additional value left on the Gift Card after the purchase of the selected products, the value may remain on the card for using in future purchases, or a refund may be provided. Similarly, in the case of a Redemption Card, if the card holder desired to purchase product(s) which exceed the redemption value of the specified redemption product(s) of the Redemption Card, then the card hold may be given the option to upgrade by paying the balance with another form of payment. This completes the purchase transaction by the card holder.

The merchant then ships or otherwise delivers the merchandise to the card holder, or a party specified by the card holder.

While the present invention has been fully described above with particularity and detail in connection with what is presently deemed to be the invention, it will be apparent to those of ordinary skill in the art that many modifications thereof may be made without departing from the principles and concepts set forth herein. Hence, the proper scope of the present invention should be determined only by the broadest interpretation of the appended claims so as to encompass all such modifications and equivalents.

What is claimed is:

1. A business method for distributing an aquarium kit via a pre-paid card, comprising the following steps:
distributing a card comprising a card number, a swipable magnetic strip comprising card information, and a pin code, said card being associated with one of a specified monetary value or a pre-determined aquarium kit;
receiving said card number from a card holder;
redeeming said card for one of a monetary value of aquarium kit merchandise or said pre-determined aquarium kit;
delivering said aquarium kit merchandise or pre-determined aquarium kit to said card holder.

2. The method of claim 1, wherein said card is distributed through one of retail outlets, academic fundraisers, internet sale, catalog sale, or television marketing.

3. The method of claim 1, wherein said card is initially inactive when distributed and is activated upon time of sale to a customer.

4. The method of claim 1, wherein said card may be redeemed by phone.

5. The method of claim 1, wherein said card may be redeemed via a web site.

6. The method of claim 1 wherein said aquarium kit comprises transgenic fluorescent fish.

7. The method of claim 5, wherein said card is distributed by one of retail outlets, academic fundraisers, internet sale, catalog sale, or television marketing.

8. The method of claim 5, wherein said card is activated upon time of sale by a retail vendor.

9. The method of claim 5 wherein said card is activated at the time of distribution to a retail vendor.

10. A business method for distributing an aquarium kit via a redemption card, comprising the following steps:
distributing a card comprising a card number, a swipable magnetic strip comprising card information, and a pin code, said card being associated with a pre-determined aquarium kit;
receiving said card number from a card holder;
redeeming said card for said pre-determined aquarium kit delivering said pre-determined aquarium kit to said card holder.

11. The method of claim 10, wherein said card is distributed through one of retail outlets, academic fundraisers, internet sale, catalog sale, or television marketing.

12. The method of claim 10, wherein said card is initially inactive when distributed and is activated upon time of sale to a customer.

13. The method of claim 10, wherein said card may be redeemed by phone.

14. The method of claim 10, wherein said card may be redeemed via a web site.

15. The method of claim 10, wherein said aquarium kit comprises transgenic fluorescent fish.

16. The method of claim 14, wherein said card is distributed by one of retail outlets, academic fundraisers, internet sale, catalog sale, or television marketing.

17. The method of claim 14, wherein said card is activated upon time of sale by a retail vendor.

18. The method of claim 14 wherein said card is activated at the time of distribution to a retail vendor.

19. A business method for distributing an aquarium kit via a gift card, comprising the following steps:
distributing a card comprising a card number, a swipable magnetic strip comprising card information, and a pin code, said card being associated with a specified monetary value;
receiving said card number from a card holder;
redeeming said card for said specified monetary value of aquarium kit merchandise;
delivering said aquarium kit merchandise to said card holder.

20. The method of claim 19, wherein said card may be redeemed via a web site.
